(19) United States
(12) Patent Application Publication
(10) Pub. No.: US 2017/0359783 A1
(43) Pub. Date: Dec. 14, 2017

(54) Apparatus, Systems and Methods for Enhanced Dormancy Triggers and Dynamic Dormancy Timer Selection

(71) Applicant: APPLE INC., CUPERTINO, CA (US)

(72) Inventors: Sarma V. VANGALA, Cupertino, CA (US); Venkateswara Rao Manepalli, Cupertino, CA (US); Srinivas Pasupuleti, Cupertino, CA (US)

(21) Appl. No.: 15/178,361

(22) Filed: Jun. 9, 2016

(51) Int. Cl. H04W 52/02; H04W 74/08; H04W 4/02; H04W 28/06

(52) U.S. Cl. CPC H04W 52/0258; H04W 28/065; H04W 74/0833; H04W 4/025

(57) ABSTRACT

A device and corresponding method to determine a buffer status of an application buffer, communicate the buffer status to a baseband processor and determine an activation of a dormancy trigger based on the buffer status of the application buffer. Also, a device and corresponding method to derive an initial inactivity timer value based on a plurality of operational observations for a type of inactivity timer, evaluate a cost function associated with the type of inactivity timer using the initial inactivity timer value and adjust the initial inactivity timer value based on the evaluating of the cost function.

### BACKGROUND

Wireless communication systems are rapidly growing in usage. Further, wireless communication technology has evolved from voice-only communications to also include the transmission of data, such as Internet and multimedia content. A user equipment (“UE”) may be configured to establish a connection with different types of networks through the use of wireless communications protocols. Accordingly, based upon the capabilities of the hardware and software of the UE, the connection may be made with these different types of networks. For instance, the network may be a Universal Mobile Telecommunication System (“UMTS”) or Long Term Evolution (“LTE”) network for data connectivity, or the network may be a Global System for Mobile Communications (“GSM”) or Code Division Multiple Access (“CDMA”) network for voice connectivity.

While utilizing a broadband, packet based system for the transmission of text, digitized voice, video and multimedia, such as an UMTS Terrestrial Radio Access Network (“UTRAN”), a Radio Resource Control (“RRC”) part of the protocol stack is responsible for the assignment, configuration and release of radio resources between the UE and the UTRAN. Two basic modes that the UE can operate are defined as “idle mode” and “UTRA RRC connected mode,” or simply “connected mode.” In idle mode, the UE is required to request a RRC connection from the UTRAN whenever it wants to send any user data or respond to a page for receiving data from an external data network such as a push server.

When in a UTRAN RRC connected mode, the UE can be in one of four states: Cell_DCH, wherein a dedicated channel is allocated to the UE in the uplink and downlink directions to exchange large amounts of data; Cell_FACH, wherein common channels are used, a Random Access Channel (“RACH”) is used in the uplink and a Foreword Access Channel (“FACH”) is used in the downlink, to exchange a small amount of data and no dedicated channel is allocated to the UE; Cell_PCH, wherein the UE uses Discontinuous Reception (“DRX”) to monitor broadcast messages and pages through a Paging Indicator Channel (“PICH”) and no uplink activity is possible; and URA_PCH, wherein a UTRAN Registration Area (“URA”) update procedure is triggered through URA reselection.

In the idle mode, when the UE requests an RRC connection, the network decides whether to move the UE to the CELL_DCH or CELL_FACH state. Conversely, when the UE is in an RRC connected mode, the network can decide when to release the RRC connection. The network may move the UE from one RRC state to another before releasing the connection or instead of releasing the connection. The state transitions are typically triggered by data activity or inactivity between the UE and network. Since the network may not know when the UE has completed a data exchange for a given application, the network maintains the RRC connection for a pre-determined time period in anticipation of additional data exchanges with the UE.

Maintaining the connection can reduce latency as opposed to re-establishing a previously released connection that can require a call set-up and radio resource allocation. An RRC connection release message can be sent by the UTRAN to release the signal link connection and all radio resources between the UE and the UTRAN. The RRC connection release message can be sent in response to a Signaling Connection Release Indicator (“SCRI”) message sent to the network by the UE after a pre-determined period of inactivity. The length of time to wait before sending the message can be fixed by the UE.

Fast dormancy technology has been incorporated into wireless broadband standards such as the third generation partnership project (“3GPP”) standards (e.g., UMTS) and the Institute of Electrical and Electronics Engineers (“IEEE”) wireless technologies to save the power consumption of the UE by switching between different mobile device activities states. When transferring data, the UE is in Cell_DCH state and uses the high speed channels to transmit and receive data. The UE sends a SCRI message to the Radio Network Controller (“RNC”) without an information element (“IE”) “SCRI Cause.” By doing this, the UE requests a release of signaling connections and a move to idle mode. In response, the network puts the connection in idle state in which the physical connection is removed while the IP address is maintained.

In LTE, any data transmission requires that the UE is in “high power” RRC connected state. With all data applications there are often short moments when no data is sent or received and during those moments connected state DRX can save energy. Connected state DRX (“C-DRX”) cyclically wakes up and shuts down the receiver circuits in order to save energy. In LTE, C-DRX allows the UE to periodically sleep and not continuously decode the physical downlink control channel (“PDCCH”) and the physical downlink shared channel (“PDSCH”). Similarly, for VoLTE type of applications, the enhanced Node B (“eNB”) can allocate resources in a semi-persistent scheduling fashion (“SPS”). Those resources are available periodically and no additional signaling is required. This is particularly useful for applications such as voice.

### SUMMARY

Described herein are apparatus, systems and methods for enhanced dormancy triggers and dynamic dormancy timer selection. A method may comprise determining, by an application processor of a user equipment (“UE”), a buffer status of an application buffer, communicating, by the application processor, to a baseband processor of the UE the buffer status of the application buffer, and determining, by the baseband processor, an activation of a dormancy trigger based on the buffer status of the application buffer.

Further described herein is a device comprising a non-transitory memory having a program stored thereon, an application processor and a baseband processor. The execution of the program causes the processor to perform operations comprising determining, by the application processor, a buffer status of an application buffer, communicating, by the application processor, the buffer status of the application buffer to the baseband processor, and determining, by the baseband processor, an activation of a dormancy trigger based on the buffer status of the application buffer.

Further described herein is a method comprising recording, by a baseband processor, a plurality of operational observations of a user equipment (“UE”) based on a type of inactivity timer, deriving, by the baseband processor, an initial inactivity timer value based on the operational observations, evaluating, by the baseband processor, a cost function associated with type of inactivity timer using the initial inactivity timer value, and adjusting, by the baseband processor, the initial inactivity timer value based on the evaluating of the cost function.

### BRIEF DESCRIPTION OF THE DRAWINGS

FIG. 1 shows an exemplary UE for enhanced dormancy triggers and dynamic dormancy timer selection according to various embodiments described herein.

FIG. 2 shows a system for communicating information from an application processor to a baseband processor according to various embodiments described herein.

FIG. 3 shows an exemplary method for enhanced dormancy triggers according to various embodiments described herein.

FIG. 4 shows an exemplary method for dynamic dormancy timer selection according to various embodiments described herein.

FIG. 5 shows an exemplary application context database 500 accessible to the baseband processor 130 of the UE 100 according to various embodiments described herein.

### DETAILED DESCRIPTION

The exemplary embodiments may be further understood with reference to the following description and the appended drawings, wherein like elements are referred to with the same reference numerals. The exemplary embodiments describe an apparatus, system and method for dynamic dormancy timer selection within a mobile device, such as a user equipment (“UE”) associated with an LTE network. In the exemplary embodiments, the mobile device will be described as a UE associated with LTE networks. However, it will be understood by those skilled in the art that UEs operating in accordance with other network standards may also implement the exemplary embodiments in accordance with the functionalities and principles described herein.

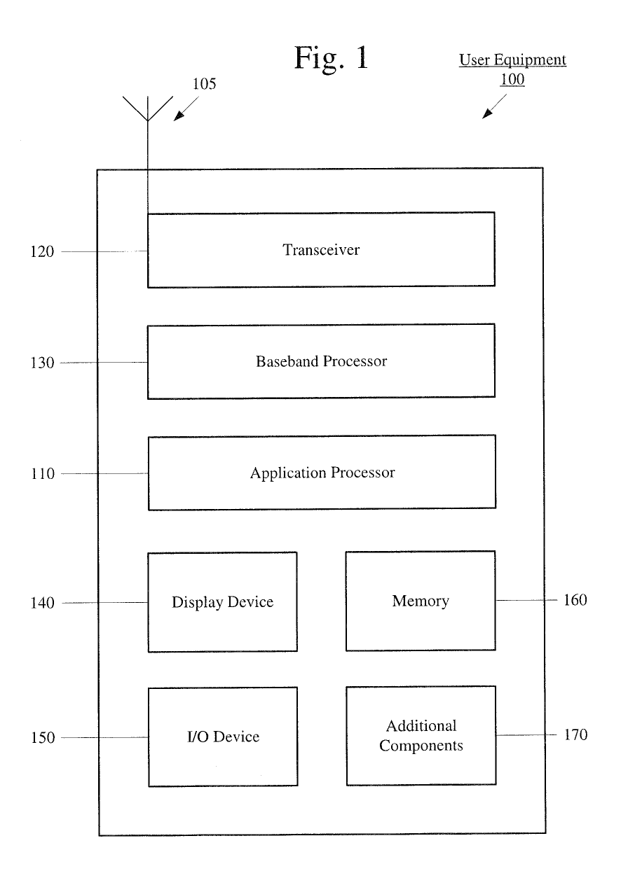

FIG. 1 shows an exemplary UE 100 for improved dynamic dormancy timer selection according to various embodiments described herein. The UE 100 may represent any electronic device that is configured to perform wireless functionalities. For example, the UE 100 may be a portable device such as a phone, a smartphone, a tablet, a phablet, a laptop, a wearable computing device, etc. In another example, the UE 100 may be a stationary device such as a desktop terminal. The UE 100 may include an antenna 105 connected to a transceiver 120, which is connected to a baseband processor 130, which is further connected to an applications processor 110. The UE 100 may further include a display 140, an I/O device 150, a memory arrangement 160 that are accessible by the baseband processor 130 or the applications processor 110. Those skilled in the art will understand that the UE 100 may also include additional components 170, for example, a Bluetooth/WiFi transceiver, further input devices (e.g., a keypad, a touchscreen, etc.), a battery, etc.

The application processor 110 may be used to perform operations such as, but not limited to, dynamically adjusting the fast dormancy (“FD”) triggers within the UE 100. It should be noted that the exemplary embodiments are described as being performed by the application processor 110 and the baseband processor 130. However, either of these components may perform the described functionalities without the other component. In addition, other components may also perform some or all of the functionalities described herein. The application processor 110, the transceiver 120 and the baseband processor 130 may be, for example, general purpose processors, a digital signal processor, an application specific integrated circuit (“ASIC”), another type of integrated circuit and these processors and integrated circuits may execute software programs or firmware.

The transceiver 120 and the baseband processor 130 may be used to perform operations such as, but are not limited to, scanning the network for specific radio frequency bands, such as LTE bands in the HPLMN of the UE 100, exchanging information with one or more mobile switching centers, etc. Furthermore, the baseband processor 130 may also perform learning functions to perform adjustments to the dormancy timers.

In order to achieve optimal power and performance gains using FD trigger mechanisms, the application processor 110 may choose when to activate, or trigger, the FD function. Conventionally, the baseband processor 130 may trigger FD if there is no data in a baseband buffer for a predetermined time period (e.g., T seconds, wherein T is the time to trigger FD after there is no active data). However, this implementation may lead to false triggers. For instance, a false trigger may occur when the baseband buffer is empty but the Transmission Control Protocol (“TCP”) socket buffers are not empty. Accordingly, the baseband processor 130 may falsely assume that there is no data and mistakenly trigger FD activation.

It may be noted that a mismatch between the application processor 110 TCP buffer status and the baseband processor 130 buffer status may be due to any number of scenarios. For instance, these scenarios may include, but are not limited to, the TCP is using a flow control protocol, the TCP is waiting for an acknowledgment (“ACK”) message, the TCP is running a back off timer that is not aligned with the value T selected by the baseband processor 130, etc.

One skilled in the art would understand that the TCP uses an end-to-end flow control protocol to limit the flow of data from the sender and allow the TCP receiver to receive and process the data reliably. Accordingly, having a mechanism for flow control is useful in a wireless network using entities of diverse communication speeds. For example, if an enhanced Node B (“eNB”) on an LTE network sends data to the UE that is slowly processing received data, the UE may utilize the flow control protocol to regulate the data flow to prevent the UE from being overwhelmed. Furthermore, when a sender TCP fails to receive an ACK from a receiver after sending data to the receiver, the sender TCP re-sends the data to the receiver. Accordingly, the sender TCP may buffer unacknowledged data from the receiver. In regards to the back off timer, the UE 100 may implement a random back off time from zero and use this timer to back off from retrying connecting with the eNB (e.g., via a RACH procedure).

According to the exemplary embodiments described herein, the TCP stack of the application processor 110 may provide an indication to the baseband processor 130 of the total buffer status combined across all open sockets and the interface buffers. The indication provided to the baseband processor 130 will allow for informed decision-making capabilities as to whether to trigger FD. More specifically, the baseband processor 130 may not only examine its current queue status, but the baseband processor 130 may also examine the TCP socket buffers at the application processor 110. While FD mechanisms may be used in a UMTS network, the exemplary embodiments described herein provide for the mechanisms to be implemented within an LTE network.

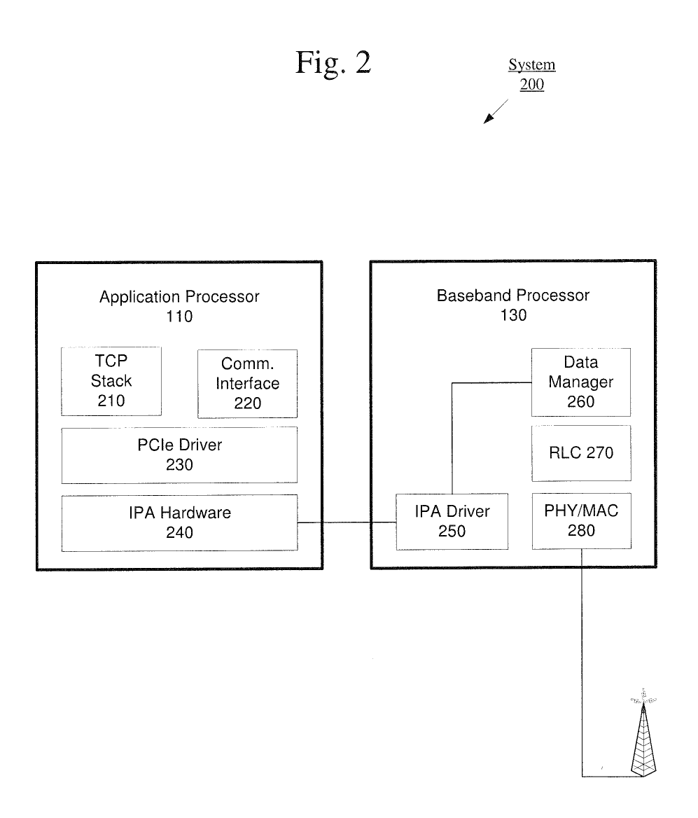

FIG. 2 shows a system 200 for communicating information from the application processor 110 to the baseband processor 130 according to various embodiments described herein. The exemplary application processor 130 may include a TCP stack 210, a communication interface 220 (e.g., as Qualcomm MSM Interface (“QMI”)), a high-speed serial computer expansion bus such as a Peripheral Component Interconnect express (“PCIe”) driver 230, and Internal Packet Accelerator (“IPA”) hardware 240. The IPA hardware 240 may be described as a programmable protocol processor hardware block that is designed to support generic hardware processing of uplink (“UL”) and downlink (“DL”) IP packets.

The exemplary baseband processor 130 may include an IPA driver 250 in communication with the IPA hardware 240 of the application processor 110. The baseband processor 130 may also include a data manager 260, a Radio Link Control (“RLC”) component 270 and a Physical/Media Access Control (“PHY/MAC”) component 280. Furthermore, the exemplary baseband processor 130 may be in communication with the antenna 105 via the transceiver 120. The data manager 260 may be in communication with the IPA driver 250 and the RLC component. Furthermore, the data manager 260 may also have access to a database, such as an application context database. The application context database will be described in greater detail below.

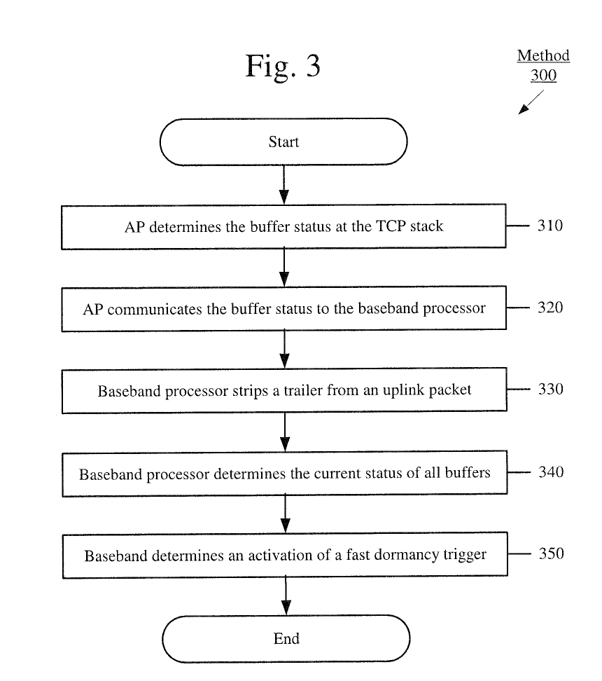

FIG. 3 shows an exemplary method 300 for improved dynamic dormancy timer selection according to various embodiments described herein. It is noted that the entirety of method 300 may be performed by a mobile device, such as the UE 100 of FIG. 1, as well as the components of the UE 100, such as the application processor 110 and the baseband processor 130 described in system 200 of FIG. 2.

According to one exemplary embodiment of the method 300, in 310 the application processor 110 may determine the status for application buffers associated with one or more TCP stacks 210 being executed by the application processor 110 (e.g., the TCP socket buffers). It may be noted that the application buffer is not limited to the exemplary TCP socket buffers discussed above, as the application buffer may be associated with any buffer available to the application processor 110. In 320, the application processor 110 may communicate the buffer status of the TCP stack 210 to the baseband processor 130. For instance, an indication of the application buffer status may be included within a trailer to every UL data packet that is sent from the TCP stack 210 of the application processor 110 to the baseband processor 130.

In 330, the baseband processor 130 may then strip the trailer of a received UL packet. In 340, the baseband processor 130 may then check for the current application buffer status, as well as the buffer status at the baseband buffer(s). Finally, in 350, the baseband processor may determine whether or not to activate the FD trigger based on all of the buffer status information received from the application processor 110 and determined for the baseband buffers. Furthermore, the FD trigger may additionally or alternatively be based on the type of the applications that are currently running.

It may be noted that since this additional information is appended onto a user data packet, this in-band communication may not have any impact on overhead or power consumption. Accordingly, despite the fact that the baseband buffer(s) may be empty, the baseband processor 130 may now be aware of the application buffer status for every TCP socket buffer, or the combined buffer status across all the TCP sockets, or the buffer status per flow at the application processor 110. Thus, method 300 may prevent a false trigger of FD when there is data still waiting in the TCP stack 210.

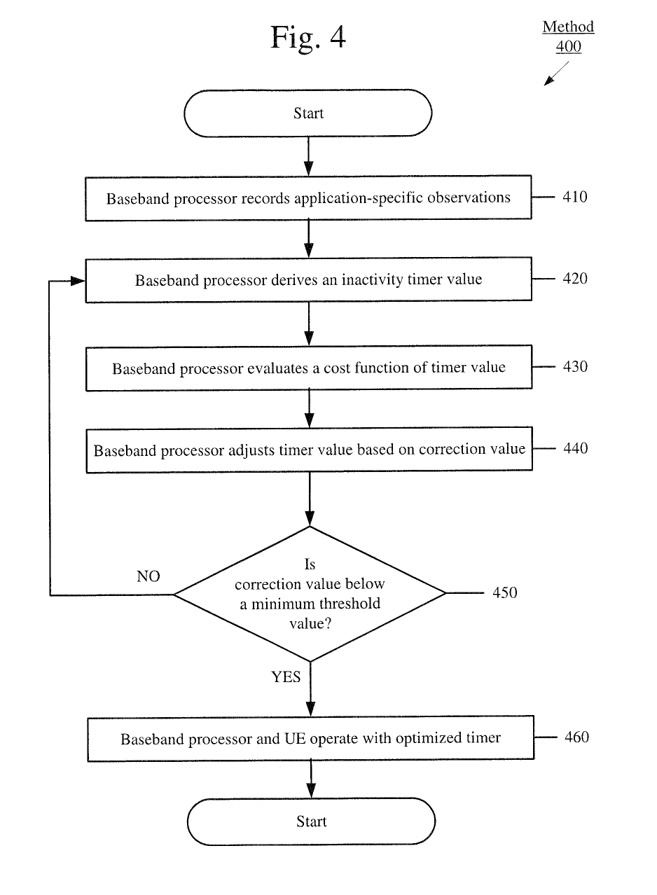

FIG. 4 shows an exemplary method 400 for dynamic dormancy timer selection according to various embodiments described herein. While method 300 improves the FD trigger mechanism, method 400 allows for the dynamic adjustment of the characteristics of the trigger mechanism. The TCP socket buffer status discussed above may be a reflection of a type of application that is active in the application processor 110. Furthermore, this specific active application may exhibit a data activity pattern.

Without dynamically adjusting the FD timer settings based on the data activity pattern, false trigger activations may continue to exist. For instance, a FD trigger may be set to T=2 seconds, wherein the FD trigger is activated when there is no data on either the application processor 110 socket buffer or the baseband processor 130 buffer for two seconds. However, there may be an active application being executed by the application processor 110 that exhibits a data pattern of transmitting and/or receiving packet(s) every five seconds. It is possible that though this application is active on the application processor 110, the current FD trigger will prematurely activate due to the short timer setting (e.g., 2 seconds). Accordingly, the activation of the FD trigger would then lead to more RRC connections and reconnections, increased power consumption, and ultimately, decreased performance of the UE 100.

In the exemplary method 400, the baseband processor 130 may optimize a plurality of cost functions associated with any number of inactivity timers employed by the UE 100. Specifically, the method 400 may be described as a reinforcement learning method to allow the baseband processor 130 to dynamically adjust the dormancy timers.

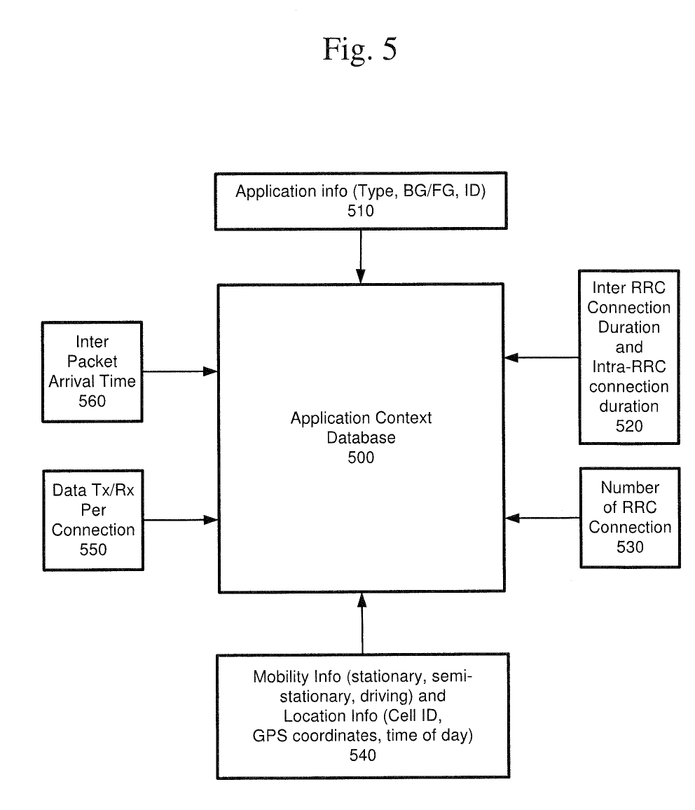

In 410, the baseband processor 130 may record a set of application-specific observations within an application context database. FIG. 5 shows an exemplary application context database 500 accessible to the baseband processor 130 of the UE 100 according to various embodiments described herein. As illustrated in FIG. 5, the application context database 500 may receive information related to any number of details related to a particular application that is active on the application processor 110. These application-specific observations may include, but are not limited to, application information 510 (e.g., type, background/foreground “BG/FG”, ID, etc.), inter-RRC connection duration and intra-RRC connection packet duration 520, number of RRC connections 530, mobility information (e.g., stationary, semi-stationary, driving, etc.) and location information 540 (e.g., cell ID, GPS coordinates, time of day, etc.), data transmission and reception per connection 550, inter-packet arrival time 560, etc.

Based on the observations recorded in 410, in 420 the baseband processor 130 may derive an initial output value for an inactivity timer value, y. In 430, the baseband processor 130 may evaluate the cost function of the initial output value for the inactivity timer and associate a reward. For instance, the reward may be based on a binary value, wherein the inactivity timer value y is either good (0x1) or bad (0x0). The good value indicates that the selected inactivity timer value has improved the cost function, while the bad value indicates that the selected inactivity timer value has worsened the cost function.

In 440, the baseband processor 130 may adjust the inactivity timer value based on the evaluation of the cost function in 430. More specifically, the reward is provided as feedback to the learning model used in the baseband processor 130, wherein the inactivity timer is either increased or decreased by a correction value, t, based on a good value or a bad value.

As the baseband processor 130 continues to learn from the adjustments to the initial inactivity timer value, y, the correction value, Δ, will continue to diminish. Eventually, the correction value, Δ, will approach a predefined minimum threshold value, x (e.g., x milliseconds). In 450, the baseband processor 130 may determine whether that correction value A has achieved the minimum threshold value, x. If the minimum threshold value x has not been achieved, the method 400 may return to 420, wherein the initial inactivity timer value is replaced with the adjust inactivity timer value. If the minimum threshold value x has been achieved, the method 400 may advance to 460, wherein the baseband 130 and the UE 100 may continue to operate with an optimized inactivity timer.

With regards to the types of timers available, a plurality of inactivity timers for the UE 100 in baseband-connected mode may be used for improving power and performance. As discussed above, a FD timer may utilize a predetermined time period, T, to trigger a FD when there is no active data. Additional inactivity timers may include an inactivity time to switch clock (“CLK”) from high speed to low speed.

The selection of static inactivity timers may not be optimal due to the fact that switching between high power and low power states may require greater power consumption. According to the exemplary embodiments described herein, method 400 allow the baseband processor 130 to select an optimal inactivity timer based on an application type and a data pattern through the use of self-learning, wherein different timers may use different cost function analysis such as the observations illustrated in FIG. 5.

For example, in the FD trigger mechanism, the cost function analysis may find an inactivity timer value for FD trigger for each application type based on minimizing a number of RRC connections during the active time of the application and an inter-RRC connection duration. In a clock mode switch, the cost function analysis may find an inactivity timer value based on minimizing a number of clock mode switches (e.g., switching between HIGH and LOW) during the active time of the application.

It should also be noted that the method 400 of FIG. 4 may be performed continuously throughout the lifecycle of an active application. As those skilled in the art will understand, the characteristics of the application may change as different functionalities are invoked by the user of the UE 100. Accordingly, the FD timer settings may change throughout the lifecycle.

It may be noted that once the FD is triggered and the connection is released, it is always possible to trigger a new connection immediately. If this scenario of back-to-back connection release and connection open happens frequently, it may lead to an increase in signaling overhead at the eNB while also increasing the power due to a greater number of connections. In order to avoid such situations, the baseband processor 130 may provide a back off timer to the networking stack. The networking stack may stop any further data until the expiration of the timer (e.g., expiration state), thereby preventing a new connection before the timer expires (e.g., active state). Accordingly, this back off timer may act as a guard for triggering the new connection. However, the usage of the back off timer may be based on the type of the applications that are running. For example, if an up coming connection is for a foreground user data or for a real-time application, and if the back off timer is running, it may not be desirable to stop the connection since the user experience may be impacted. Alternatively, the back off timer may be applied for connections initiated by the background applications without impacting the user experience.

It may be noted that the exemplary embodiments are described with reference to the LTE and LTE-Advanced communication system. However, those skilled in the art will understand that the exemplary embodiments may be applied to managing dynamic dormancy timers within any wireless communication schemes including those having different characteristics from the LTE scheme.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

1. A method, comprising:
determining, by an application processor of a user equipment (“UE”), a buffer status of an application buffer;
communicating, by the application processor, to a baseband processor of the UE the buffer status of the application buffer; and
determining, by the baseband processor, an activation of a dormancy trigger based on the buffer status of the application buffer.

2. The method of claim 1, further comprising:
activating a back off timer based on a type of application currently active at the application processor, wherein a flow of data to the UE is based on a state of the back off timer.

3. The method of claim 1, further comprising:
determining, by the baseband processor, a second buffer status of a baseband buffer, wherein the activation of the dormancy trigger is further based on the second buffer status of the baseband buffer.

4. The method of claim 3, wherein the application buffer and the baseband buffer are each a plurality of buffers.

5. The method of claim 1, wherein the application buffer is a Transmission Control Protocol (TCP) socket buffer.

6. The method of claim 1, wherein the communicating the buffer status, comprises:
inserting the buffer status into a trailer of an uplink (UL) data packet that is sent from the application processor to the baseband processor.

7. The method of claim 6, further comprising:
stripping, by the baseband processor, the trailer from the data packet to determine the buffer status.

8. A method, comprising:
at a baseband processor of a user equipment (“UE”):
deriving an initial inactivity timer value based on a plurality of operational observations for a type of inactivity timer;
evaluating a cost function associated with the type of inactivity timer using the initial inactivity timer value; and
adjusting the initial inactivity timer value based on the evaluating of the cost function.

9. The method of claim 8, further comprising:
recording the plurality of operational observations of a user equipment (“UE”) based on the type of inactivity timer.

10. The method of claim 8, wherein the adjusting the initial inactivity timer comprises:
determining a correction value for the initial inactivity timer value.

11. The method of claim 10, further comprising:
determining whether the correction value is below a threshold value;
when the correction value is below the threshold value, operating the UE using the adjusted inactivity timer value; and
when the correction value is above the threshold value, further evaluating the cost function associated with the type of inactivity timer using the adjusted inactivity timer value.

12. The method of claim 8, wherein the operational observations include one of application information, inter-RRC connection duration, intra-RRC connection packet duration, a number of RRC connections, mobility information location information, data transmission and reception per connection, or inter-packet arrival time.

13. The method of claim 8, wherein the type of inactivity timer includes one of a fast dormancy (FD) timer, an inactivity time to switch clock from high speed to low speed timer, or an inactivity to trigger a connected state mode change timer.

14. The method of claim 8, wherein the cost function is based on one of minimizing a number of RRC connections during an active time of an application or minimizing a number of clock mode switches.

15. A user equipment (“UE”), comprising:
an inactivity timer; and
a baseband processor configured to derive an initial inactivity timer value based on a plurality of operational observations for a type of the inactivity timer, evaluate a cost function associated with the type of the inactivity timer using the initial inactivity timer value and adjust the initial inactivity timer value based on the evaluating of the cost function.

16. The UE of claim 15, further comprising:
a memory arrangement, wherein baseband processor is further configured to record the plurality of operational observations and store the operational observations in the memory arrangement.

17. The UE of claim 15, wherein the baseband processor is further configured to determine a correction value for the initial inactivity timer value, determine whether the correction value is below a threshold value, when the correction value is below the threshold value, operating the UE using the adjusted inactivity timer value and when the correction value is above the threshold value, further evaluating the cost function associated with the type of inactivity timer using the adjusted inactivity timer value.

18. The UE of claim 15, wherein the operational observations include one of application information, inter-RRC connection duration, intra-RRC connection packet duration, a number of RRC connections, mobility information location information, data transmission and reception per connection, or inter-packet arrival time.

19. The UE of claim 15, wherein the type of inactivity timer includes one of a fast dormancy (FD) timer, an inactivity time to switch clock from high speed to low speed timer, or an inactivity to trigger a connected state mode change timer.

20. The UE of claim 15, wherein the cost function is based on one of minimizing a number of RRC connections during an active time of an application or minimizing a number of clock mode switches.
